(19) United States
(12) Patent Application Publication
(10) Pub. No.: US 2007/0042818 A1
(43) Pub. Date: Feb. 22, 2007

(54) Headset unit

(76) Inventor: Andrew Lippman, Hoboken, NJ (US)

Correspondence Address: HARSHAW RESEARCH INCORPORATED, P O BOX 418, OTTAWA, KS, 66067, US

(21) Appl. No.: 11/207,117

(22) Filed: Aug. 18, 2005

(51) Int. Cl. H04M 1/00

(52) U.S. Cl. 455/575.2

(57) ABSTRACT

A headset unit for interfacing user-supplied communications and audio player devices with a speaker or headphones. The headset unit includes a cradle having a first area for releasably holding the communications device and a second area for releasably holding the audio player. The cradle includes circuitry for electrically connecting the audio outlets of the telephone and audio player with a cradle audio outlet which may then be connected to headphones. Additional circuitry provides a plurality of audio control modes selectable by a user. Specifically, audio signals may be selectively received by the cradle audio outlet only from the telephone, only from the audio player, from both simultaneously, or only from the telephone during a call. A rechargeable power source is attached to the cradle for selectively recharging the telephone or audio player.

### BACKGROUND OF THE INVENTION

This invention relates generally to an audio device and, more particularly, to a headset unit that interfaces an audio player with a communications device.

Two of the most common and popular portable electronic devices are cell phones and music players. It is now very common for individuals to attach a cell phone to their pants, belt, or carry it in their purse. Music players, such as a Walkman or iPod, are often similarly used by walkers and joggers. A significant problem is that attempting to carry both electronic devices at the same time is very difficult. Namely, sportswear typically worn while walking or jogging does not lend itself very well to holding these devices while leaving the arms and hands free to move.

Garments and devices such as “fanny packs” which are worn about a person's waist have been proposed in the art for holding various miscellaneous items. Further, devices attempting to integrate cell phones with radio or recorded music players have also been proposed, such as in U.S. Pat. Nos. 6,006,115 and 6,606,506. While assumably effective for their intended purposes, the existing devices do not facilitate the use of the user's existing cellular or digital telephone and music player by interfacing the two devices through a specialty cradle.

Therefore, it is desirable to have a headset unit for releasably holding a user's communications and music playing devices so that the user's hands remain free. Further, it is desirable to have a headset unit that selectively directs audio signals from either the phone or music player to a single headset, said signals being delivered exclusively from one or the other or from both simultaneously. Finally, it is desirable to have a headset unit that includes a rechargeable power source for recharging the respective power sources of the telephone and music player when they are electrically connected to the cradle.

### SUMMARY OF THE INVENTION

A headset unit according to the present invention includes a cradle having a first area for receiving the telephone and a second area for receiving an audio player. The cradle includes straps for releasably holding the electronic devices in place. The headset unit includes circuitry for electrically connecting an audio outlet on the cradle with respective audio outlets on the telephone and audio player. A speaker, such as headphones, may be electrically connected to the cradle audio outlet.

The headset unit includes circuitry supporting a plurality of audio control modes. Specifically, a user may, using an audio control mode selector switch, cause audio signals to be sent to the headphones from only the telephone, only the audio player, or from both simultaneously. Audio signals from the audio player may be blocked automatically when the telephone is activated or allowed to continue through the call.

A power source is positioned on the cradle of the headset unit for selectively recharging the batteries of the telephone and audio player. More particularly, the unit includes circuitry for connecting the power source to a telephone power input jack and an audio player input jack. A power selector switch enables a user to selectively control which device, if any, should be recharged by the cradle power source.

Therefore, a general object of this invention is to provide a headset unit having a cradle for releasably holding a user-supplied portable communications device and a portable audio player.

Another object of this invention is to provide a headset unit, as aforesaid, that interfaces audio signals from the telephone and audio player to a single audio input outlet.

Still another object of this invention is to provide a headset unit, as aforesaid, that includes a speaker or headphones connected to the audio input outlet for communicating audio signals from the telephone or audio player to a user.

Yet another object of this invention is to provide a headset unit, as aforesaid, that selectively allows audio signals from the telephone and audio player to be delivered to or inhibited from the cradle audio outlet.

A further object of this invention is to provide a headset unit, as aforesaid, having a power supply for selectively recharging the batteries of the user-supplied telephone and audio player.

Other objects and advantages of the present invention will become apparent from the following description taken in connection with the accompanying drawings, wherein is set forth by way of illustration and example, an embodiment of this invention.

### BRIEF DESCRIPTION OF THE DRAWINGS

FIG. 1 is a front perspective view of a headset unit according to the present invention with a user-supplied telephone and music player releasably secured thereto;

FIG. 2 is a rear perspective view of the headset unit as in FIG. 1;

FIG. 3a is a rear view of the headset unit as in FIG. 2;

FIG. 3b is a sectional view taken along line 3B-3B of FIG. 3A;

FIG. 4a is perspective view of an outer side of a singular headphone for use with the headset unit;

FIG. 4b is a perspective view of an inner side of a singular headphone for use with the headset unit;

FIG. 5 is a perspective view of a stereo headphone device for use with the headset unit;

FIG. 6 is a side view of the headset as in FIG. 1;

FIG. 7 is an elevated side view of the headset as in FIG. 6 with the user-supplied telephone and music player removed;

FIG. 8 is a perspective view from another angle of the headset as in FIG. 2;

FIG. 9 is a bottom perspective view of the headset as in FIG. 1;

FIG. 10 is a diagram of a first audio control mode;

FIG. 11 is a diagram of a second audio control mode;

FIG. 12 is a diagram of a third audio control mode;

FIG. 13 is a diagram of a first power control mode;

FIG. 14 is a diagram of a second power control mode; and

FIG. 15 is a diagram of a third power control mode.

### DESCRIPTION OF THE PREFERRED EMBODIMENT

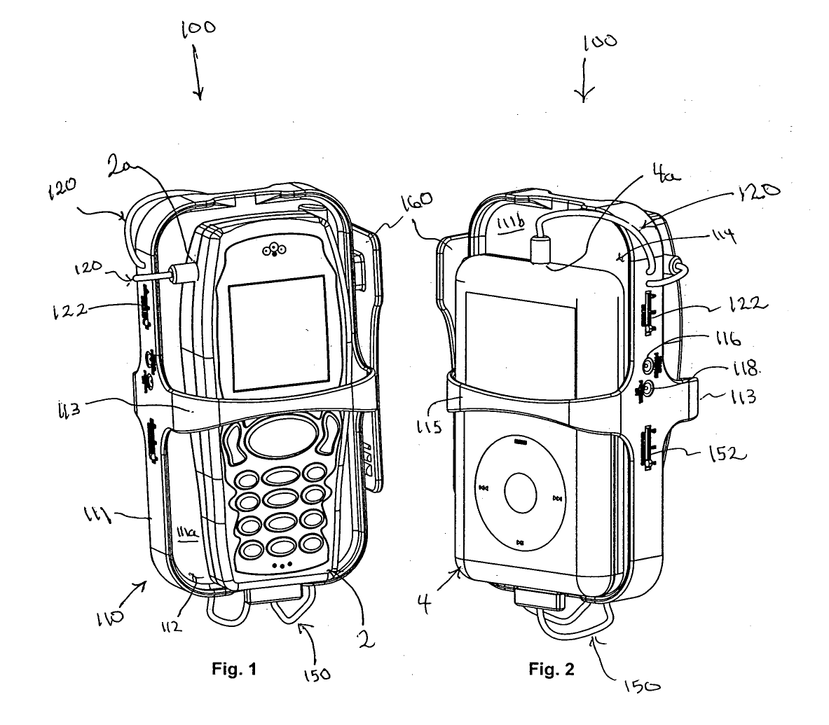

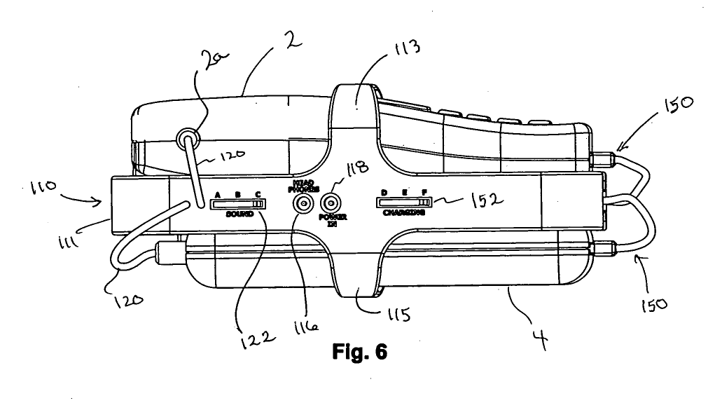

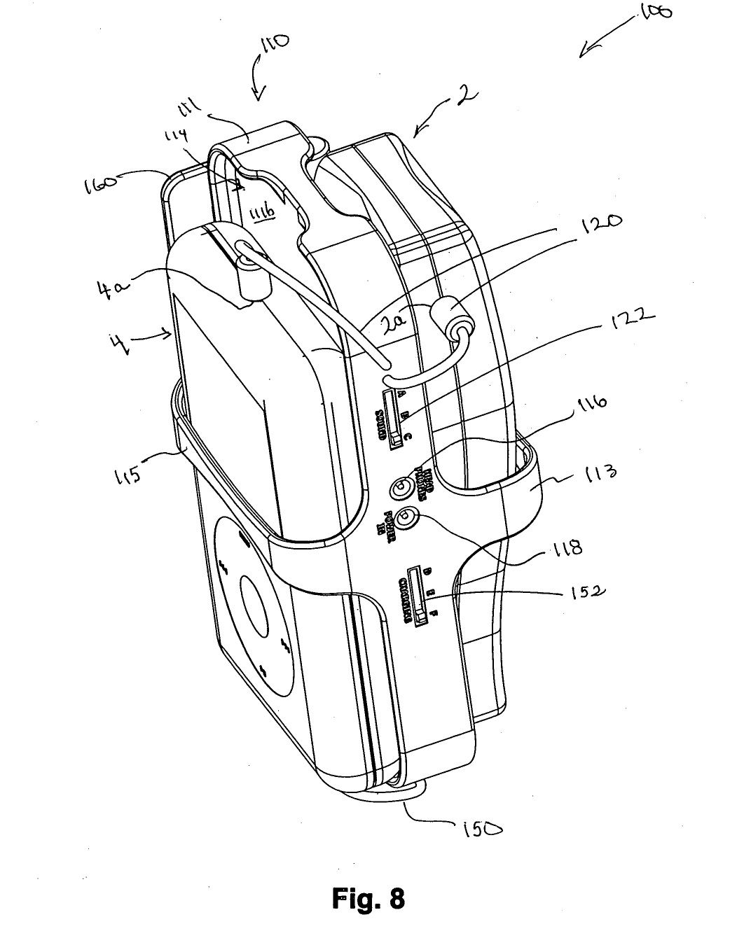

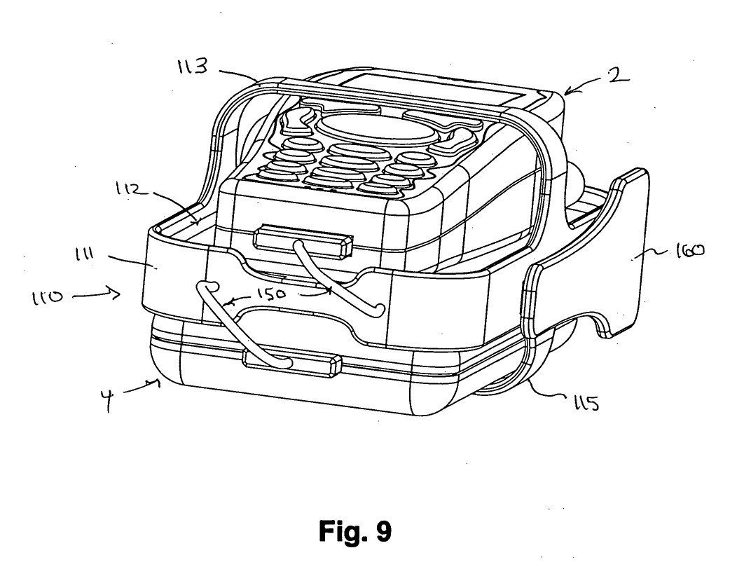

A headset unit according to the present invention will now be described in detail with reference to FIGS. 1 through 12 of the accompanying drawings.

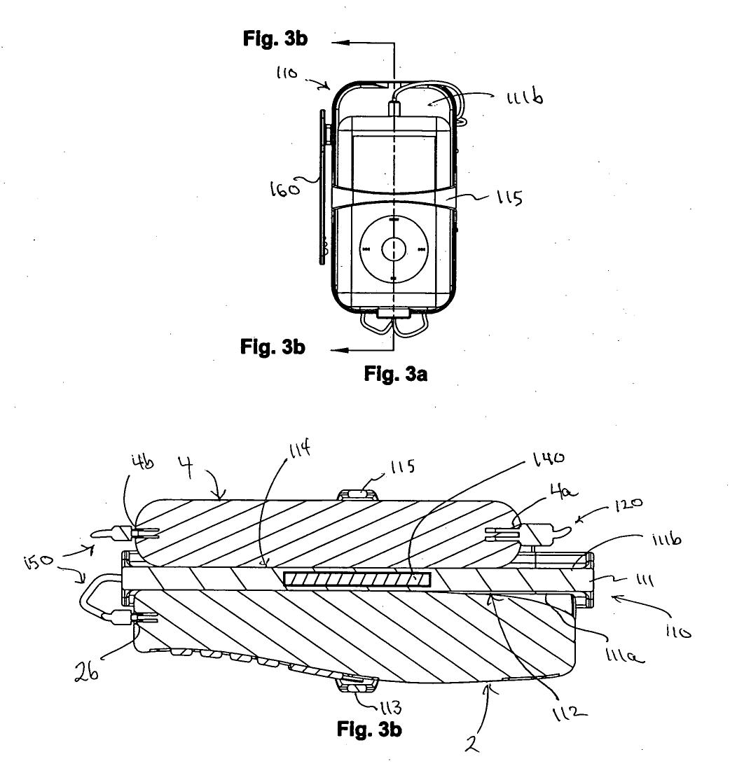

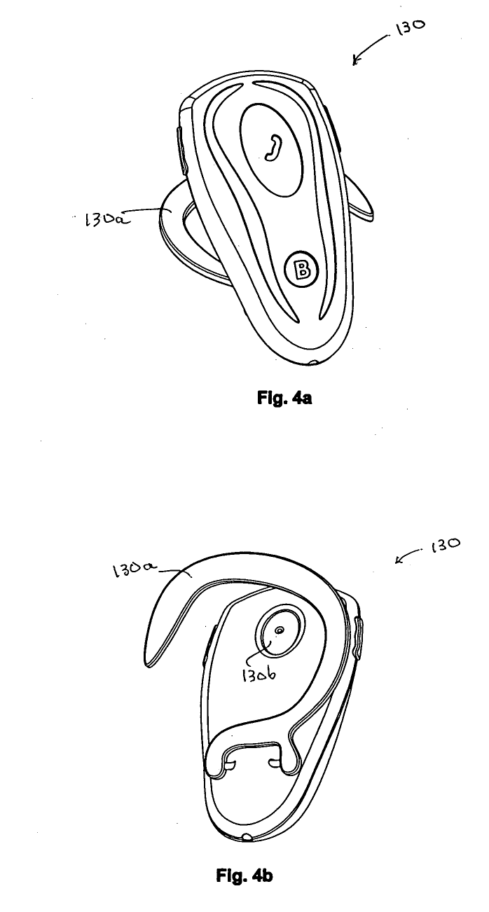

A headset unit 100 for use with a portable communications device 2 and a portable audio player 4 includes a cradle 110 as shown in FIGS. 1-3 and 6. The cradle 110 includes a first area 112 for receiving the communications device 2 (FIG. 1) and a second area 114 for receiving the audio player 4 (FIG. 2). The cradle 110 includes means for removably securing the communications device 2 to the cradle first area 112 and means for removably securing the audio player 4 to the cradle second area 114. The cradle 110 preferably includes a wall 111 having opposed first and second faces 111a, 111b; the first face 111a preferably presents the first area 112, and the second face 111b preferably presents the second area 114 (FIG. 3b). A clip 160 may be attached to the cradle 110 for selectively attaching the cradle 110 to an article of clothing.

The means for securing the communications device 2 is preferably a first strap 113, and the means for securing the audio player 4 is preferably a second strap 115, but the securing means may alternatively include clips, pockets, or other securing components In a preferred embodiment, the cradle 110, the first strap 113, and the second strap 115 include an integrated construction of an elastomeric material to securely receive respective communications devices 2 of various sizes and respective audio players 4 of various sizes. The communications device 2 is preferably a mobile telephone, though other communications devices may be used, such as a pager, a 2-way radio, and others.

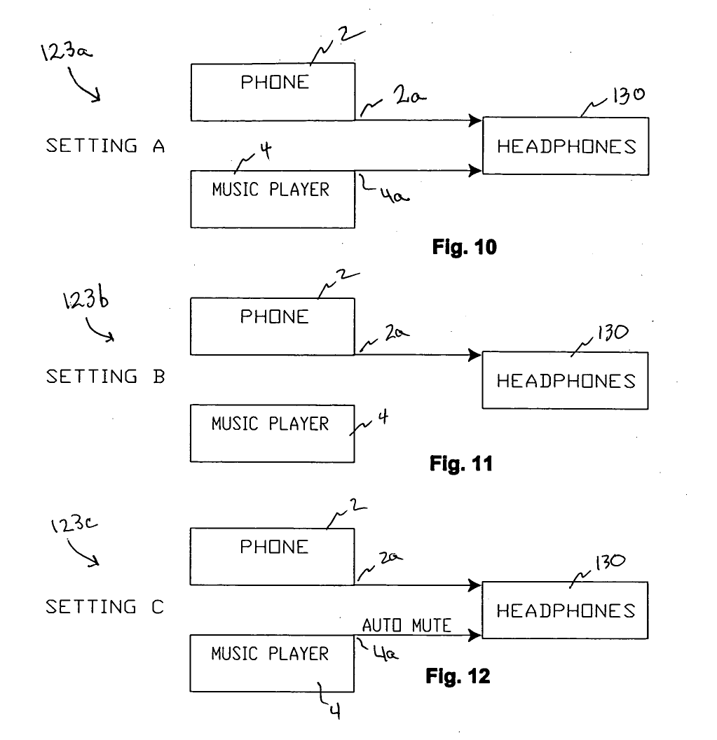

The cradle 110 includes circuitry 120 to selectively connect an audio outlet 2a of the communications device 2 and an audio outlet 4a of the audio player 4 to an audio outlet 116 attached to the cradle 110. The circuitry 120 preferably includes means for selectively allowing audio signals from the communications device audio outlet 2a to reach the cradle audio outlet 116 and selectively allowing audio signals from the audio player audio outlet 4a to reach the cradle audio outlet 116, creating a plurality of user-selectable audio control modes as shown in FIGS. 10 through 12. The means for selectively allowing respective audio signals is preferably a user-operable audio switch 122 (also referred to as an audio control mode selector switch) electrically connected to the cradle audio outlet 116, as shown in FIGS. 1 and 2. The audio control mode selector switch 122 also allows a user to select among the plurality of user-selectable audio control modes.

In a first audio control mode 123a, the audio signals from the communications device audio outlet 2a and the audio signals from the audio player audio outlet 4a are allowed to reach the cradle audio outlet 116 (FIG. 10). In a second audio control mode 123b, only audio signals from the communications device audio outlet 2a are allowed to reach the cradle audio outlet 116 (FIG. 11). In a third audio control mode 123c, the audio signals from the communications device audio outlet 2a are allowed to reach the cradle audio outlet 116 and, only when the communications device 2 is not in use, the audio signals from the audio player audio outlet 4a are allowed to reach the cradle audio outlet 116, effectively muting the audio player 4 when the communications device 2 is in use (FIG. 12).

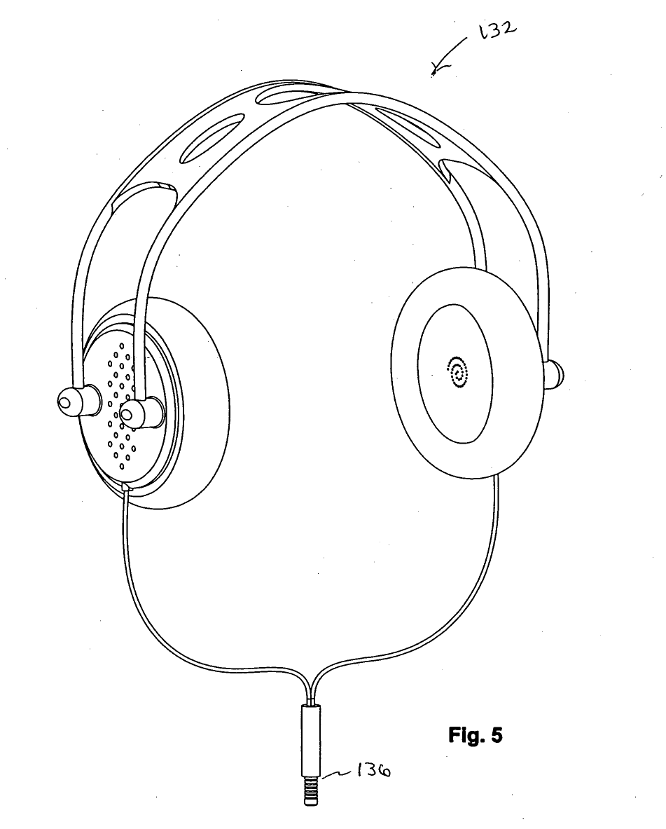

A speaker is in communication with the cradle audio outlet 116 to make the audio signals that reach the cradle audio outlet 116 audible to a user. The speaker is preferably a headphone 130 or set of headphones 132 as shown in FIGS. 4a through 5. A singular headphone 130 is shown in FIGS. 4a and 4b. The singular headphone 130 includes an ear clip 130a for removably attaching the headphone 130 to a person's ear and an actual speaker member 130b. Alternatively, traditional stereo (dual) headphones 132 may be utilized as the speaker. The headphones, of course, may be connected to the audio outlet 116 with traditional wires and input jack 136 or may utilize a wireless connection.

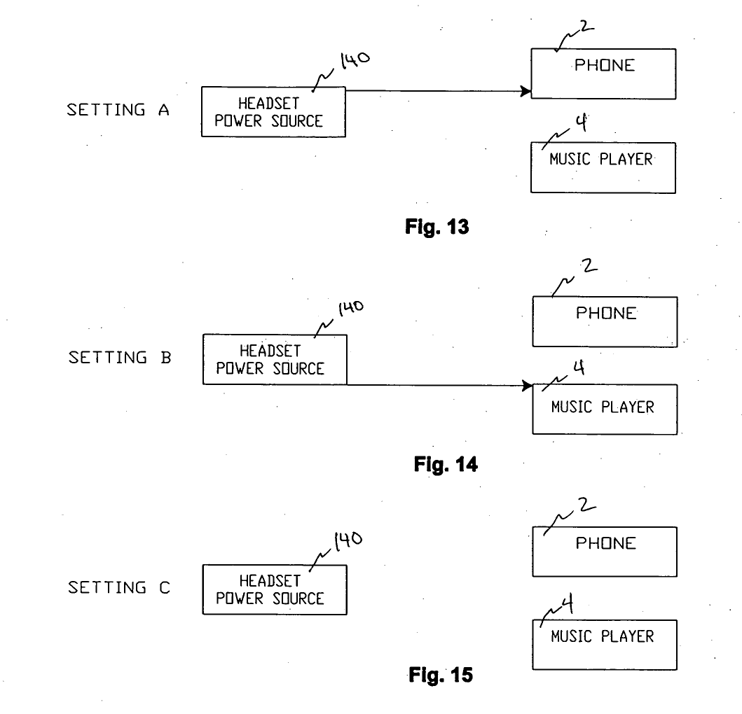

A power source 140 may be attached to the cradle 110, and additional circuitry 150 may releasably connect the power source 140 to a power input jack 2b of the communications device 2 and a power input jack 4b of the audio player 4. To create a plurality of user-selectable power control modes as shown in FIGS. 13 through 15, the additional circuitry 150 preferably includes means for selectively allowing current from the power source 140 to reach the communications device power input jack 2b for charging the communications device 2 (FIG. 13), selectively allowing current from the power source 140 to reach the audio player power input jack 4b for charging the audio player 4 (FIG. 14), and selectively allowing current from the power source 140 to reach neither the communications device power input jack 2b nor the audio player power input jack 4b (FIG. 15). The means for selectively allowing current is preferably a user-operable power selector switch 152 electrically connected to the power source 140 (FIGS. 3b). The user-operable power selector switch 152 also allows a user to select among the plurality of user-selectable power control modes.

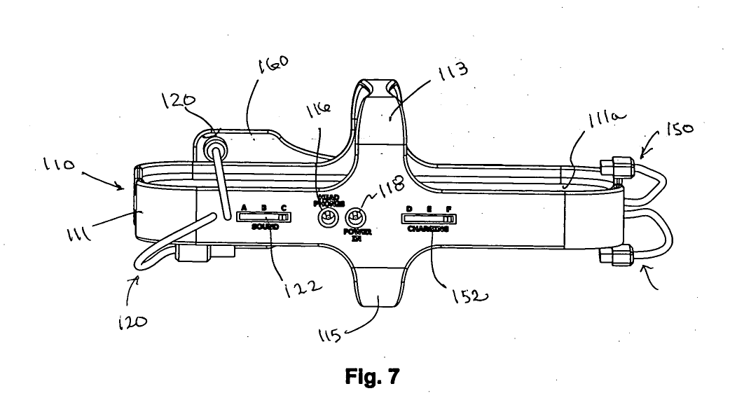

The power source 140 is preferably a rechargeable battery (FIG. 3b), and a power input jack 118 (FIG. 7) is preferably attached to the cradle 110 and in communication with the rechargeable battery for allowing the rechargeable battery to be selectively recharged.

In use, the communications device 2 may be secured to the first area 112 by the securing means 113, and the audio player 4 may be secured to the second area 114 by the securing means 115. The circuitry 120 may then be connected to the communications device audio outlet 2a and the audio device audio outlet 4a. The additional circuitry 150 may be connected to the communications device power input jack 2b and the audio device power input jack 4b. The clip 160 may be used to attach the cradle 110 to an article of clothing, and the headphones 130 may be worn.

The user may select an audio control mode by using the audio control mode selector switch 122, causing audio signals to be sent to the speaker from only the communications device 2, only the audio player 4, or from both simultaneously. Audio signals from the audio player 4 may be optionally muted automatically when the communications device 2 is in use.

The user may also selectively control which device, if any, the power source 140 should recharge by manipulating the power selector switch 152, and the user may selectively recharge the power source 140 by connecting the power input jack 118 to an external power source, such as a 110-volt alternating current power outlet (not shown).

It is understood that while certain forms of this invention have been illustrated and described, it is not limited thereto except insofar as such limitations are included in the following claims and allowable functional equivalents thereof.

What is claimed is as follows:

1. A headset unit for use with a portable communications device and a portable audio player, said unit comprising a cradle having:
a first area for receiving the communications device;
means for removably securing the communications device to said cradle first area;
a second area for receiving the audio player; and
means for removably securing the audio player to said cradle second area.

2. The unit as in claim 1, further comprising circuitry to selectively connect an audio outlet of the communications device and an audio outlet of the audio player to an audio outlet attached to said cradle.

3. The unit as in claim 2, wherein said circuitry includes means for selectively allowing audio signals from the communications device audio outlet to reach said cradle audio outlet and selectively allowing audio signals from the audio player audio outlet to reach said cradle audio outlet.

4. The unit as in claim 2, wherein said circuitry includes means for selectively allowing:
only audio signals from the communications device audio outlet to reach said cradle audio outlet;
only audio signals from the audio player audio outlet to reach said cradle audio outlet;
the audio signals from the communications device audio outlet and the audio signals from the audio player audio outlet to reach said cradle audio outlet; and
the audio signals from the communications device audio outlet to reach said cradle audio outlet and, only when the communications device is not in use, the audio signals from the audio player audio outlet to reach said cradle audio outlet.

5. The unit as in claim 4, wherein said means for selectively allowing respective audio signals is a user-operable audio switch electrically connected to the cradle audio outlet.

6. The unit as in claim 4, further comprising:
a power source attached to said cradle;
additional circuitry to connect said power source to a power input jack of the communications device and a power input jack of the audio player, said additional circuitry including means for selectively allowing current from said power source to reach, respectively:
the communications device power input jack for charging the communications device;
the audio player power input jack for charging the audio player; and
neither the communications device power input jack nor the audio player power input jack.

7. The unit as in claim 1, further comprising:
a rechargeable battery attached to said cradle; and
circuitry to connect said rechargeable battery to a power input jack of the communications device and a power input jack of the audio player.

8. The unit as in claim 7, wherein the circuitry includes means for selectively allowing current from said rechargeable battery to reach, respectively:
the communications device power input jack for charging the communications device;
the audio player power input jack for charging the audio player; and
neither the communications device power input jack nor the audio player power input jack.

9. The unit as in claim 8, wherein said means for selectively allowing current is a user-operable power selector switch.

10. The unit as in claim 7, further comprising a power input jack attached to said cradle and to said rechargeable battery for allowing said rechargeable battery to be selectively recharged.

11. The unit as in claim 1, further comprising a clip attached to said cradle for selectively attaching said cradle to an article of clothing.

12. The unit as in claim 1, wherein:
said means for securing the communications device to said cradle first area includes a first strap;
said means for securing the audio player to said cradle second area includes a second strap; and
said cradle, said first strap, and said second strap include an integrated construction of an elastomeric material to securely receive respective communications devices of various sizes and respective audio players of various sizes.

13. The unit as in claim 1, wherein the portable communications device is a mobile telephone.

14. The unit as in claim 1, wherein:
said cradle includes a wall having opposed first and second faces;
said first face presents said first area; and
said second face presents said second area.

15. A headset unit for use with a mobile telephone and a mobile audio player, said unit comprising:
a cradle having a first area for receiving the telephone and a second area for receiving the audio player;
circuitry for releasably connecting an audio outlet of the telephone and an audio outlet of the audio player to an audio outlet attached to said cradle; and
a speaker in communication with said cradle audio outlet.

16. The headset unit as in claim 15, further comprising:
a plurality of user-selectable audio control modes for selectively allowing audio signals to reach said cradle audio outlet; and
means for selecting among said plurality of user-selectable audio control modes.

17. The headset unit as in claim 16, wherein said plurality of user-selectable audio control modes includes:
a first audio control mode allowing only audio signals from the telephone audio outlet to reach said cradle audio outlet;
a second audio control mode allowing only audio signals from the audio player audio outlet to reach said cradle audio outlet;
a third audio control mode allowing the audio signals from the telephone audio outlet and the audio signals from the audio player audio outlet to reach said cradle audio outlet.

18. The headset unit as in claim 17, wherein said plurality of user-selectable audio control modes includes a fourth audio control mode allowing the audio signals from the telephone audio outlet to reach said cradle audio outlet and, only when the telephone is not in use, the audio signals from the audio player audio outlet to reach said cradle audio outlet.

19. The headset unit as in claim 18, further comprising:
a power source attached to said cradle;
additional circuitry releasably connecting said power source to a power input jack of the telephone and a power input jack of the audio player;
a plurality of user-selectable power control modes for selectively allowing current from said power source to energize, respectively:
the telephone power input jack for charging the telephone;
the audio player power input jack for charging the audio player; and
neither the telephone power input jack nor the audio player power input jack;
means for selecting among said user-selectable power control modes;
a first strap attached to said cradle for securing the telephone to said first area; and
a second strap attached to said cradle for securing the audio player to said second area.

20. The headset unit as in claim 15, further comprising:
a power source attached to said cradle;
additional circuitry releasably connecting said power source to a power input jack of the telephone and a power input jack of the audio player;
a plurality of user-selectable power control modes for selectively allowing current from said power source to energize, respectively:
the telephone power input jack for charging the telephone;
the audio player power input jack for charging the audio player; and
neither the telephone power input jack nor the audio player power input jack; and
means for selecting among the user-selectable power control modes.
